(19) United States
(12) Patent Application Publication
(10) Pub. No.: US 2016/0012738 A1
(43) Pub. Date: Jan. 14, 2016

(54) INTERACTIVE SOCIAL LEARNING NETWORK

(71) Applicant: Neema Shafigh, Aliso Viejo, CA (US)

(72) Inventor: Neema Shafigh, Aliso Viejo, CA (US)

(21) Appl. No.: 14/796,997

(22) Filed: Jul. 10, 2015

Related U.S. Application Data
(60) Provisional application No. 62/022,985, filed on Jul. 10, 2014.

(51) Int. Cl. G09B 5/06; G06Q 50/20; H04L 29/06

(52) U.S. Cl. CPC G09B 5/06; H04L 65/403; G06Q 50/20

(57) ABSTRACT

An online interactive social learning system which enables a multiplicity of end-users to interact in connection with educational areas of interest. A host site provides the multiplicity of end-users with access to an educational services system by way of an interface. The host site is stored on a social learning services server system such that the educational services system is accessible to the multiplicity of end-users by way of a communications network. Information needed during the operation of the educational services system is stored on database server system. A study groups pool enables the multiplicity of end-users to search for and join one or more study groups based on educational criteria. A collaboration tools package enables the end-users to interact with one another by way of the communications network. A mobile application provides for operating system independent communications with the host site.

### CROSS REFERENCED TO RELATED APPLICATION

This application claims the benefit of U.S. Provisional Application No. 62/022,985 filed on Jul. 10, 2014, the entirety of said application is incorporated herein by reference.

### BACKGROUND

1. Field of the Invention

The field of the present invention generally relates to online educational network systems. More particularly, the field of the invention relates to an apparatus and a method for an online interactive social education system which enables end-users to interact in connection with educational objectives by way of a communications network.

2. Background

As social networking sites become increasingly popular, many schools and educators have begun to realize the benefits of utilizing such networking to expand learning opportunities. Study groups are online areas for students and faculty to study together, send messages to the group, and share files. Whether aiming to make education more personal or to improve their skills outside of the classroom, many students are seeking out various ways to connect with classmates online. Professors are trying to come up with ways to interact with students and beyond the classroom. Further, many educational institutions now encourage students to organize study groups through various popular networking sites.

A drawback, however, is that there is no centralized online location dedicated to education where students and educators can gather so as to interact and make classes and studying more personal. Moreover, many popular networking sites are not dedicated to education, and thus many study groups are subject to interference by outside online users entering and disrupting the study group.

What is needed, therefore, is an interactive social learning network for students to interact with one another in connection with a common interest in education, whereby students residing all over the world may connect with one another and experience a more balanced and leveled approach to education.

### SUMMARY

In its most general aspect, the present invention includes an apparatus and a method for an online interactive social learning system which enables a multiplicity of end-users to interact in connection with educational areas of interest. The online interactive social learning system comprises an educational services system to enable the multiplicity of end-users to create personal profile pages. A host site provides the multiplicity of end-users with access to the educational services system by way of an interface. The host site is stored on a non-transient machine-readable medium of a social learning services server system, such that the educational services system is accessible to the multiplicity of end-users by way of a communications network. Information needed during the operation of the educational services system is stored on a non-transient machine-readable medium of a database server system. A study groups pool enables the multiplicity of end-users to search for and join one or more study groups based on educational criteria. A collaboration tools package enables the end-users to interact with one another by way of the communications network.

In one aspect, the collaboration tools package includes an interactive desktop application which enables each of the end-users to take study notes and also to display those notes, in real-time, to all the other end-users participating in the study group. In another aspect, the collaboration tools package may further include one or more video/audio conferencing applications, whereby the end-users in a study group may see and hear each other in real-time.

In another aspect, the collaboration tools package comprises an interactive whiteboard, whereby the various end-users in each study group may simultaneously participate in adding and altering study-related content on the interactive whiteboard. In still another aspect, the online interactive social learning system may further comprise a tutoring tools package comprising one or more applications which facilitate the end-users searching for and receiving online tutoring services in real time.

In still another aspect, the invention includes an online interactive social learning system which enables a multiplicity of end-users to interact in connection with educational areas of interest, comprising: an educational services system configured on a server, the educational services system including a study tools package including a profile builder configured to enable an end-user to create a personal profile page, the study tools package also including an application for joining and/or creating a study group of one or more other end-user in accordance with educational criteria entered into the application by the end-user; a host site in communication with the server, the host site providing the end-user access to the educational services system by way of an interface, the host site accessible by the end-user through a communications network; and a database system in operable communication with the server and comprising a non-transient machine-readable medium for storing information related to the operation of the educational services system, including storing the personal profile page created by the end-user.

In one alternative aspect, the study tools package includes one or more additional services that are provided to the end-users, the one or more services selected from the group consisting of a study groups pool, a collaboration tools package, and a tutoring tools package.

In another alternative aspect, the profile builder enables the end-users to each create a personal profile page including one or more item of personal information, the one or more items of personal information selected from the group consisting of at least a username, a personal password, an identity of a school attended by the end-user, area of study, class schedule, existing study group memberships, and a membership status.

In still another alternative aspect, the study groups pool includes at least one software application stored on the server system providing access to the study groups pool by the end-user through the host site. In another alternative aspect, the study groups pool enables the end-users to search for and join one or more study groups, and to create new study groups. In yet another alternative aspect, the application configures the server to allow end-users to “buddy” each other so as to create study groups based on education-related criteria. In still another alternative aspect, the application is configures the server to allow the end-users to specify whether the study groups created are public study groups or private study groups.

In yet another alternative aspect, the public study groups are published by the application to the study groups pool, such that other end-users may search for and join the study groups. In another alternative aspect, information pertaining to existing study groups is stored on the database system, and wherein the interface is configured by software commands to provide for communication between the server, the study groups pool, and the information stored on the database system.

In yet another aspect, the collaboration tools package comprises a multiplicity of applications that include software commands to provide for interactions between end-users and to share educational information between end-users. In one alternative aspect, the collaboration tool package includes an interactive desktop application that, configured by software commands provided by the application, configures a desktop computer of an end-user of a study group, whereby each end-user may take study notes and also make those notes viewable, in real-time, to other end-users of the study group. In an alternative aspect, the study notes may be saved in the database and associated with the end-user's personal profile page. In another alternative aspect, each of the other end-users may specify whether or not other end-users can access the study notes associated with the personal profile page of the end-user.

In still another aspect, the collaboration tools package comprises one or more video/audio conferencing applications, whereby the end-users comprising a study group may see and hear each other in real-time. In an alternative aspect, the collaboration tools package comprises an interactive whiteboard accessible by members of the study group, whereby the members of the study group may participate in adding and altering study-related content on the interactive whiteboard which is visible by all the members of the study group. In still another alternative aspect, the collaboration tools package is stored on the memory of the server system and is accessible to the end-users by way of the interface and the host site. In yet another alternative aspect, the collaboration tools package may be stored on the memory of the database system along with the information pertaining to the operation of the collaboration tools package, and is accessible to the educational services system by way of the interface.

In another aspect, the tutoring tools package comprises one or more applications configured by software commands which facilitate the end-users searching for and receiving live, online tutoring services. In one aspect, a multiplicity of tutors are selected from among the end-users that have demonstrated suitable skills in their chosen areas of study. In another aspect, a multiplicity of tutors are employees or associates of an operator of the online interactive social learning system. In still another aspect, the online tutoring services are conveyed to the end-users by way of the one or more multimedia applications comprising the collaboration tools package. In yet another aspect, the multiplicity of tutors post their rates and areas of specialty, thereby enabling the end-users to engage tutors based on specific needs. In still another aspect, the study groups pool has an indicator that identifies those among the end-users that are registered as tutors.

In another aspect, the invention includes a method for providing an online interactive social learning system which enables a multiplicity of end-users to interact in connection with educational areas of interest, comprising: configuring an educational services system to enable a multiplicity of end-users to create personal profile pages; configuring a host site to provide the multiplicity of end-users with access to the educational services system by way of an interface; storing the host site on a non-transient machine-readable medium of a social learning services server system such that the educational services system is accessible to the multiplicity of end-users by way of a communications network; configuring a non-transient machine-readable medium of a database server system to store information needed during the operation of the educational services system; providing a study groups pool to the multiplicity of end-users, whereby the end-users may search for and join one or more study groups based on educational criteria; and providing a collaboration tools package comprising one or more multimedia applications, whereby the end-users may interact with one another by way of the communications network.

In one alternative aspect, providing the collaboration tools package further comprises providing an interactive desktop application, whereby each of the end-users may take study notes and also make those notes viewable, in real-time, to all the other end-users participating in the study group. In another alternative aspect, providing the collaboration tools package further comprises providing one or more video/audio conferencing applications, whereby the end-users comprising the study group may see and hear each other in real-time. In still another alternative aspect, providing the collaboration tools package further comprises providing an interactive whiteboard, whereby the various end-users comprising each study group may simultaneously participate in adding and altering study-related content on the interactive whiteboard.

In one further aspect, the method further comprises providing a tutoring tools package comprising one or more applications which facilitate the end-users searching for and receiving live, online tutoring services. In one alternative aspect, the tutoring tools package further comprises selecting a multiplicity of tutors from among the end-users that have demonstrated suitable skills in their chosen areas of study. In another alternative aspect, the tutoring tools package further comprises conveying the online tutoring services to the end-users by way of the one or more multimedia applications comprising the collaboration tools package.

In a still further aspect, the invention includes a mobile application that facilitates collaborative communications between users that is independent of the users' devices operating systems.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a schematic illustrating an exemplary embodiment of an online interactive social learning system in accordance with the present invention.

FIG. 2 is a graphical representation illustrating an embodiment of the online system of FIG. 1 illustrating users connecting to the online system server through the Internet and a host site.

FIG. 3 illustrates an exemplary computer system which may be programmed or configured with software commands to carry out the various embodiments of the present invention.

FIG. 4 is a schematic diagram of one embodiment of a Web based system and application providing the on-line interactive social learning system in accordance with the present invention.

FIG. 5 is a schematic diagram of one embodiment of a mobile application for use on a user's mobile device to connect to and participate in the on-line interactive social learning system in accordance with the present invention.

### DETAILED DESCRIPTION OF THE PREFERRED EMBODIMENTS

In the following description, numerous specific details are set forth in order to provide a thorough understanding of the present invention. It will be apparent, however, to one of ordinary skill in the art that the present invention may be practiced without these specific details. In other instances, well known components or methods have not been described in detail but rather in a block diagram, or a schematic, in order to avoid unnecessarily obscuring the present invention. Further specific numeric references such as “first driver,” may be made. However, the specific numeric reference should not be interpreted as a literal sequential order but rather interpreted that the “first driver” is different than a “second driver.” Thus, the specific details set forth are merely exemplary. The specific details may be varied from and still be contemplated to be within the spirit and scope of the present invention. The term “coupled” is defined as meaning connected either directly to the component or indirectly to the component through another component.

Throughout the description reference will be made to various software programs and hardware components that provide and carryout the features and functions of the various embodiments of the present invention. Software programs may be embedded onto a machine-readable medium. A machine-readable medium includes any mechanism that provides, stores or transmits information in a form readable by a machine, such as, for example, a computer, server or other such device. For example, a machine-readable medium includes read only memory (ROM); random access memory (RAM); magnetic disk storage media; optical storage media; flash memory devices; digital video disc (DVD); EPROMs; EEPROMs; flash memory; magnetic or optical cards; or any type of media suitable for storing electronic instructions.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages. Also, an algorithm may be implemented with lines of code in software, configured logic gates in software, or a combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

In an embodiment, the logic consists of electronic circuits that follow the rules of Boolean Logic, software that contain patterns of instructions, or any combination of both.

The term “server” is used throughout the following description. Those skilled in the art understand that a server is a computer program that provides services to other computer programs running on the same computer or processor as the server application is running, and/or other computers or processors different from the computer or processor on which the server is running Often, the computer or processor on which the server program is running is referred to as the server, although other programs and applications may also be running on the same computer or processor. It will be understood that a server forms part of the server/client model. As such, the processor running the server program may also be a client, requesting services from other programs, and also operate as a server to provide services to other programs upon request. It is understood that the computer or processor upon which a server program is running may access other resources, such as memory, storage media, input/output devices, communication modules and the like.

Similarly, a cloud server is a server that provides shared services to various clients that access the cloud server through a network, such as a local area network and the Internet. In a cloud based system, the server is remote from the clients, and various clients share the resources of the cloud server. Information is passed to the server by the client, and returned back to the client through the network, usually the Internet.

In general, the present invention describes an apparatus and a method for an online interactive social learning system which enables a multiplicity of end-users to interact in connection with educational areas of interest. The online interactive social learning system comprises an educational services system to enable the multiplicity of end-users to create personal profile pages.

A host site provides the multiplicity of end-users with access to the educational services system by way of an interface. The host site is stored on a non-transient machine-readable medium of a social learning services server system, such that the educational services system is accessible to the multiplicity of end-users by way of a communications network. Information needed during the operation of the educational services system is stored on a non-transient machine-readable medium of a database server system.

A study groups pool enables the multiplicity of end-users to search for and join one or more study groups based on educational criteria. A collaboration tools package enables the end-users to interact with one another by way of the communications network. In an embodiment, the collaboration tools package includes an interactive desktop application which enables each of the end-users to take study notes and also to display those notes, in real-time, to all the other end-users participating in the study group. The collaboration tools package further includes one or more video/audio conferencing applications, whereby the end-users in a study group may see and hear each other in real-time.

In another embodiment, the collaboration tools package comprises an interactive whiteboard, whereby the various end-users in each study group may simultaneously participate in adding and altering study-related content on the interactive whiteboard.

The online interactive social learning system further comprises a tutoring tools package comprising one or more applications which facilitate the end-users searching for and receiving online tutoring services in real time.

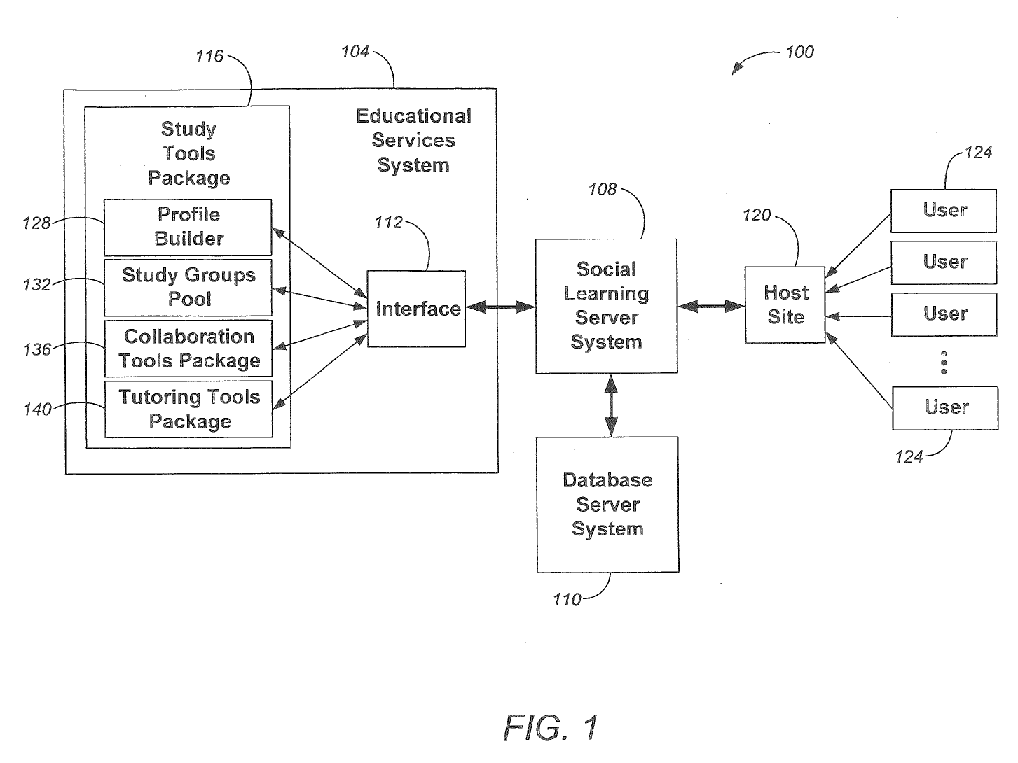

FIG. 1 is a schematic representation illustrating an exemplary embodiment of an online interactive social learning system 100 in accordance with the present invention. The online interactive social learning system 100 comprises an educational services system 104 stored on a non-transient machine-readable medium (i.e., a memory) of a social learning server system 108. The online interactive social learning system 100 further comprises a database server system 110 which stores any information or data that may be needed during the operation of the educational services system 104.

The educational services system 104 further comprises an interface 112 which provides access to a study tools package 116. As illustrated in FIG. 1, a host site 120 provides a multiplicity of end-users 124 access to the social learning server system 108 by way of a communications network, such as the Internet. Preferably, each of the end-users 124 creates a user profile by utilizing applications stored on the memory of the social learning server system 108 and the services provided by the educational services system 104.

In one embodiment, the study tools package 116 is stored on the memory of the social learning server system 108, and the interface 112 is a software application which comprises a portion of the educational services system 104, thereby providing access to the study tools package 116. In another embodiment, the study tools package 116 may be stored on the memory of the database server system 110, and the interface 112 enables interaction between the social learning server system 108 and the study tools package 116 on the database server system 110.

In another embodiment, the study tools package 116 may be services operated by one or more third-party service providers. In this embodiment, the interface 112 may comprise a connection over the communications network, such as an Internet connection, whereby the social learning server system 108 may send requests to, and receive services from the one or more third-party service providers.

In the embodiment illustrated in FIG. 1, the study tools package 116 comprises services that are provided to the end-users 124, including, but not necessarily limited to a profile builder 128, a study groups pool 132, a collaboration tools package 136, and a tutoring tools package 140. The profile builder 128 provides a secure infrastructure to enable the end-users 124 to each create a personal profile page which includes personal information, such as by way of non-limiting example, at least a username, a personal password, the end-user's school, area of study, class schedule, any existing study group memberships, and a membership status. It is envisioned that the information uploaded by the end-users 124 is stored on the memory of the database server system 110 and remains accessible to the educational services system 104. Once each of the end-users 124 successfully creates a profile page, the social learning server system 108 then allows the end-user 124 to access other services comprising the study tools package 116.

The study groups pool 132 operates as a gateway which enables the end-users 124 to search for and join one or more study groups, as well as enabling the end-users 124 to create new study groups. End-user may access the educational services section through the host site, and using various screens and menus provided by the interface 112, which are provided to the end-user through processors or computers configured for the specialized purposes of the various services and/or applications provided by the study tools package by suitable programming commands included in software applications associated with the various elements of the educational services systems, social learning server system and database server system. Utilizing the screens and menus of the study groups pool, for example, allows the user to create queries for searching for, and joining one or more study groups, or to create a study group.

Preferably, the end-users 124 can “buddy” each other so as to create study groups based on their university majors, or other educational subjects of interest. In some embodiments, the study groups pool 132 enables the end-users 124 to specify whether the study groups created are public or private. Public study groups preferably are published to the study groups pool 132 so other end-users 124 may search for and join the study groups. For example, if three end-users 124 from UCLA have created a group for studying economics, another end-user 124 from Harvard, upon using the study groups pool 132 to search for economics study groups, may join the UCLA group to study economics. It will be appreciated that the study groups pool 132 enables end-users 124 from all over the world to create and participate in a wide variety of study groups based purely on educational criteria.

As discussed above, in some embodiments, the study groups pool 132 comprises at least one software application stored on the social learning server system 108, whereby the end-users 124 interact with the study groups pool 132 by way of the host site 120. Information pertaining to existing study groups may be stored on the memory of the database server system 110, and the interface 112 enables interaction between the social learning server system 108, the study groups pool 132, and the information stored on the database server system 110.

In other embodiments, the study groups pool 132 may comprise a third-party service provider which offers an infrastructure and various online tools to assist the end-users 124 with searching for and joining existing study groups, or creating new study groups, by way of the interface 112.

The collaboration tools package 136 comprises a multiplicity of applications whereby the end-users 124 can interact and share educational information. It will be understood that the applications provided are embodied in software programs that specifically configure the processor or processors of the system to accept input from the end-user, process that input, and then provide an output of some kind to the end-user in accordance with the type of application selected by the end-user.

In some embodiments, the collaboration tools package 136 comprises an interactive desktop application, whereby each of the end-users 124 may take study notes and also make those notes viewable, in real-time, to all the other end-users 124 participating in the study group. In such an embodiment the study notes entered into the system by the user may be stored in the database server system and made accessible to other users of the system, either in real time, or at a later time.

In other embodiments, the study notes placed on the interactive desktop may be moved by the end-user 124 to the user's personal profile page for longer term storage. Each of the end-users 124 may specify whether or not other end-users 124 can access the study notes saved to the personal profile page.

In some embodiments, the collaboration tools package 136 comprises one or more multimedia applications whereby the end-users 124 may communicate with one another in real-time. In some embodiments, the multimedia applications include one or more video/audio conferencing applications, whereby the end-users 124 comprising a study group may see and hear each other in real-time over the communications network. It will be appreciated that the one or more video/audio conferencing applications facilitate the various end-users 124 working together to achieve their educational goals.

In some embodiments, the one or more multimedia applications may include an interactive whiteboard, whereby the various end-users 124 comprising each study group can participate in adding and altering study-related content on the interactive whiteboard for all the end-users in the study group to see. It should be understood that the collaboration tools package 136 may include various additional multimedia applications than described above without deviating from the spirit and the scope of the present invention.

In some embodiments, the collaboration tools package 136 is stored on the memory of the social learning server system 108 and is accessible to the end-users 124 by way of the interface 112 and the host site 120. It is envisioned that information pertaining to the operation of the collaboration tools package 136 are stored on the memory of the database server system 110 and remain accessible to the educational services system 104.

In other embodiments, the collaboration tools package 136 may be stored on the memory of the database server system 110 along with the information pertaining to the operation of the collaboration tools package 136, and accessible to the educational services system 104 by way of the interface 112.

The tutoring tools package 140 comprises one or more applications which facilitate the end-users 124 searching for and receiving live, online tutoring services. In some embodiments, a multiplicity of tutors may be selectees from among the end-users 124 that have demonstrated suitable skills in their chosen areas of study. In other embodiments, the tutors may be employees or associates of an operator of the online interactive social learning system 100. In some embodiments, the online tutoring services may be conveyed to the end-users 124 by way of the one or more multimedia applications comprising the collaboration tools package 136. End-users 124 that are registered as tutors may post their rates and areas of specialty to their personal profile pages, thereby enabling the end-users 124 to engage tutors based on specific needs. Further, in some embodiments, the study groups pool 132 may indicate those among the end-users 124 that are registered as tutors, thereby simplifying searching for online tutoring services.

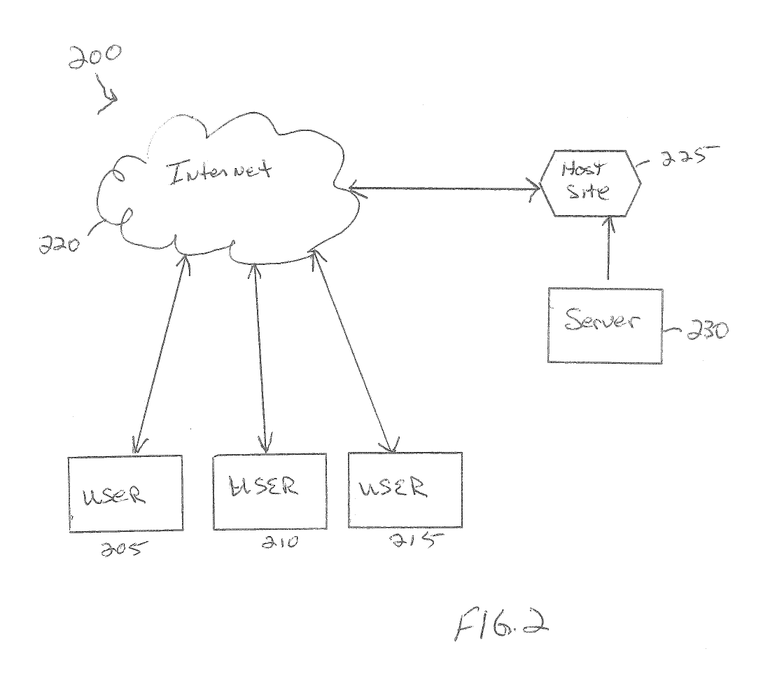

FIG. 2 is a graphical illustration of a system 200 in accordance with the description of FIG. 1 illustrating how end-users 205, 210 and 215 access host site 225 through a network 220, such as the Internet. It will be understood that users 205, 210, 215 may connect to the network in various manners, which includes directly connecting to network 220, or accessing network 220 through an intervening network, which may include Bluetooth, Wi-Fi, cellular, or other networks. Once host site 225 is accessed, users 205, 210 and 215 may access the various embodiments of the present invention available to them on server 230.

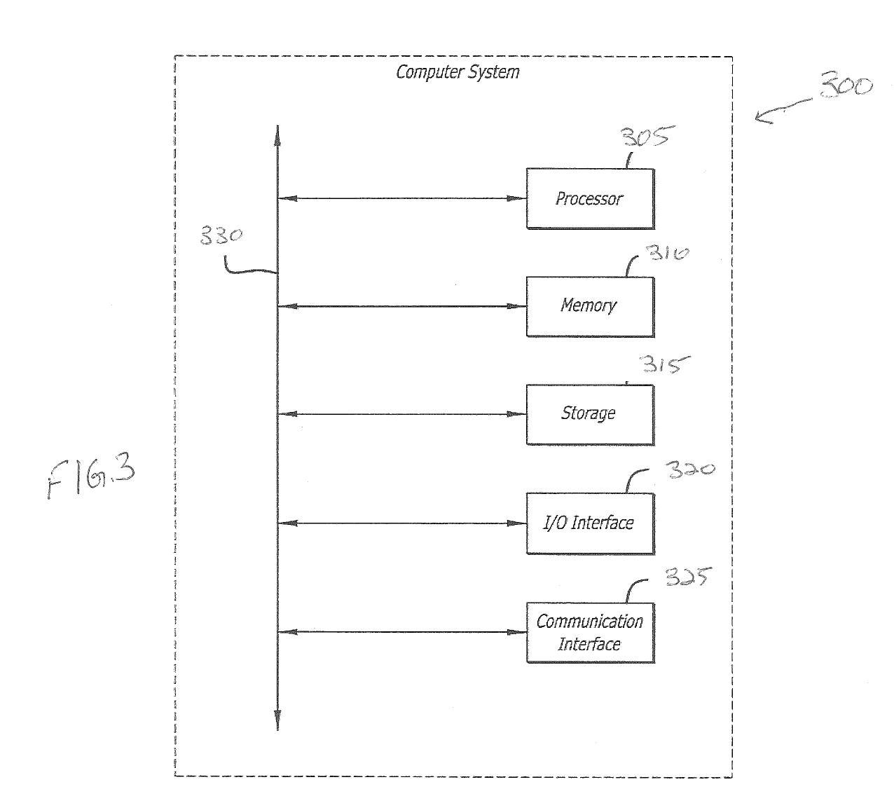

FIG. 3 illustrates an exemplary computer system 300 which may be programmed or configured with software commands to carry out the various embodiments of the present invention. Computer system 300 may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, and the like. Computer system 300 may also be a combination of multiple forms. Computer system 300 may include one or more computer systems 300, be unitary or distributed, span multiple locations, span multiple systems, or reside in a cloud (which may include one or more cloud components in one or more networks).

It will be understood by those skilled in the art that, while the following describes a computer system, such a system may be used as a desktop system used by an end-user of the various embodiments of the present invention, but is also applicable to a description of the various components of the servers, memories and databases employed by the various embodiments of the present invention.

In an embodiment, computer system 300 may include one or more processors 305, memory 310, storage 315, an input/output (I/O) interface 320, a communication interface 325, and a bus 330. Although this disclosure describes and illustrates a particular computer system having a particular number of particular components in one particular arrangement, this disclosure contemplates other forms of computer systems having any suitable number of components in any suitable arrangement.

In one embodiment, processor 305 includes hardware for executing instructions, such as those produced by software programs. Herein, reference to software may encompass one or more applications, byte code, one or more computer programs, one or more executables, one or more instructions, logic, machine code, one or more scripts, or source code, and vice versa, where appropriate. As an example and not by way of limitation, to execute instructions, processor 305 may retrieve the instructions from an internal register, an internal cache, memory 310 or storage 315; decode and execute them; and then write one or more results to an internal register, an internal cache, memory 310, or storage 325.

In an embodiment, processor 305 may include one or more internal caches for data, instructions, or addresses. Memory 310 may be random access memory (RAM), static RAM, dynamic RAM or any other suitable memory. Storage 315 may be a hard drive, a floppy disk drive, flash memory, an optical disk, magnetic tape, or any other form of storage device that can store data (including instructions for execution by a processor).

In a typical embodiment, storage 315 may be mass storage for data or instructions which may include, but is not limited to, a HDD, solid state drive, disk drive, flash memory, optical disc (such as a DVD, CD, Blue ray, and the like), magneto optical disc, magnetic tape, or any other hardware device which stores may store computer readable media, data and/or combinations thereof. Storage 315 maybe be internal or external to computer system 300 and may be located remotely from computer system 300, but in communication with computer system 300, or accessible by computer system 300.

In another embodiment, input/output (I/O) interface 320 includes hardware, software, or both, for providing one or more interfaces for communication between computer system 300 and one or more I/O devices. Computer system 300 may have one or more of these I/O devices, where appropriate. As an example but not by way of limitation, an I/O device may include one or more mouses, keyboards, keypads, cameras, microphones, monitors, displays, printers, scanners, speakers, cameras, touch screens, trackball, and the like.

In still another embodiment, a communication interface 325 includes hardware, software, or both which provides one or more interfaces for communication between one or more computer systems or one or more networks. Communication interface 325 may include a network interface controller (NIC) or a network adapter for communicating with an Ethernet or other wired-based network or a wireless NIC or wireless adapter for communication with a wireless network, such as a WI-FI network. In one embodiment, bus 330 includes hardware, software, or both coupling components of a computer system 300 to each other.

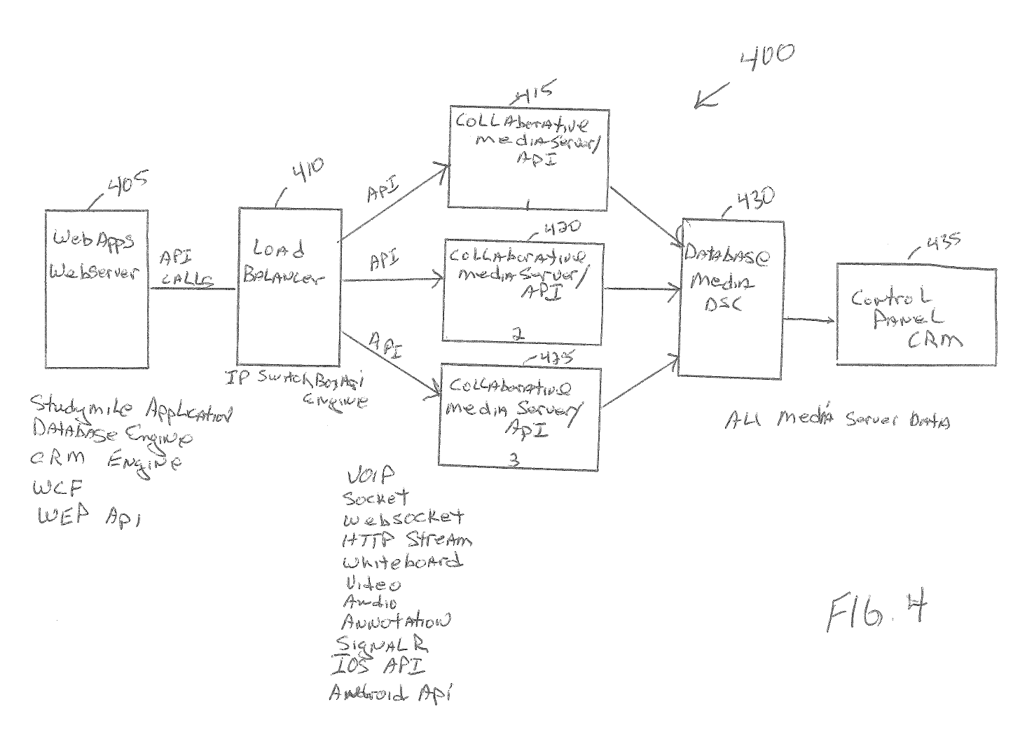

FIG. 4 is a schematic diagram illustrating an embodiment of the present invention that is accessible through the World Wide Web, and thus will be referred to herein as the Web application. This web application 400 is designed to be compatible with and accessible by not only desktop or laptop computer based systems, but also mobile systems such as, for example, tablets or other devices using the IOS or Android operating systems.

Web application 400 includes a webapps web server 405. This server may provide services such as the various applications and embodiments described above with reference to FIG. 1. Such services may also include a data base engine and a CRM engine which manages the various user accounts and the data and information associated with them. Additionally, this server may also provide a WCF (Windows Communication Foundation) service that allows multiple servers to communicate independently of their operating system or technology.

When a user establishes a communication session with one or more applications provided by server 405, API calls may be made through a load balancer 410 to access data and information stored on media servers 415, 420, and 425. Those skilled in the art will understand that media servers 415, 420, and 425 may be located in one physical location, or may be distributed at locates remote from one another. The function of the load balancer is to route the API request to the nearest server, or to route it to the server that has the most capacity available at the time of the request. Each media server 415, 420, and 425 includes media data base 430. The various processes may be monitored and/or controlled by system administrators using a control panel CRM 435.

Media servers 415, 420, and 425 may provide various services, such as a VoIP (Voice over IP) socket, a web socket, and HTTP stream, a white board that allows for interaction between users, video and audio services, and various layers, such as SignalR for providing communications for various platforms to the whiteboard application. APIs for enabling communication with the servers using IOS or Android operating systems are also provided.

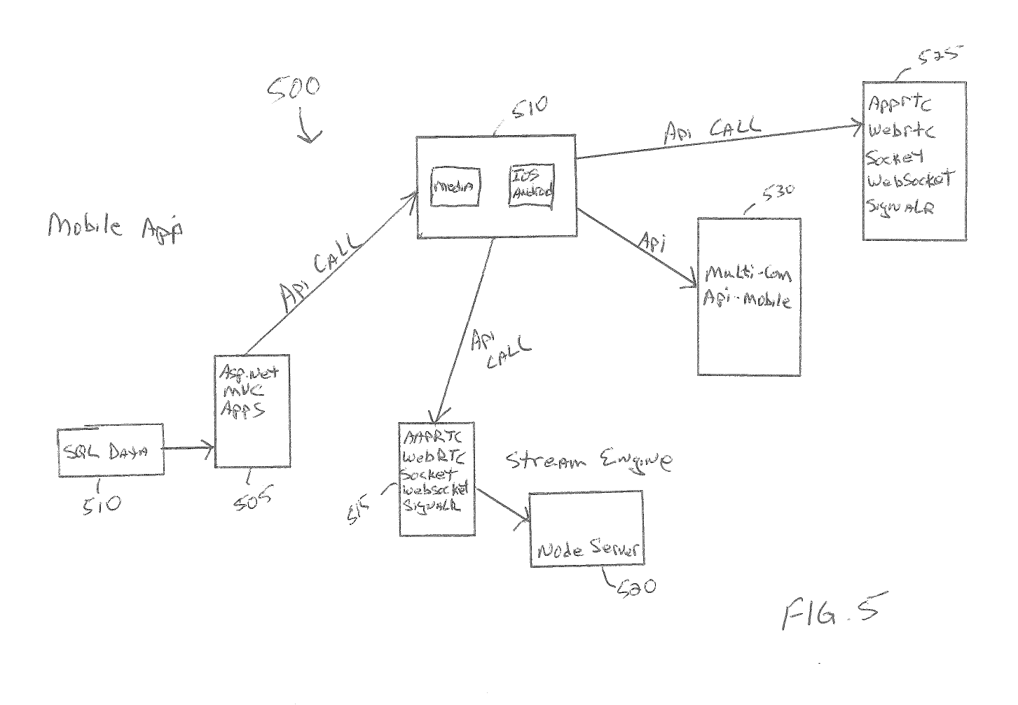

FIG. 5 is a conceptual schematic representation illustrating various program services and API calls of a mobile application 500 that may be located on a user's computer, IOS or Android device. When embodied in a mobile application, the mobile application includes a mobile app 505 that may be downloaded to a user's mobile device. The app may be downloaded or purchased from a web site, such as the web site illustrated in FIG. 1. Alternatively, the app may be downloaded or purchased from an app store, such as the Apple Store or Android Store.

Mobile app 505 may also include a SQL data base 510 for storing information related to the user, as well as any notes, audio or video, whiteboard information, or any other information or data that the user wishes to store locally on the user's mobile device. This SQL device may be used as a supplement to the data base shown in the embodiment of FIG. 1, or it may be used instead that data base.

When a user activates app 505, the app makes an API call to web server 405 of FIG. 4. As described above, when the communication session is opened, various information related to the user and the user's account may be exchanged between the mobile app and the web server to initiate the communications session. This exchange may occur automatically where the user has an existing account, or the user may be prompted to establish an account before the user is allowed access to the various services and programs provided by the web server. It will also be understood that the login process may also work on a prompt-response basis to gather user identification and passwords from users with previously established accounts.

When a service is requested by a user through the web server using the mobile app, the mobile app issues an API call to the web server which then invokes other API calls to various services to provide the service requested by the mobile user. In the embodiment illustrated in FIG. 5, for example, an API call to box 510 for various media services may result in a API call to a node server 520 which may be a virtual server hosing the media servers 415, 420, and 425 (FIG. 4). Such a call may be made through the various communications services 515 such as APPRTC, which facilitates communication between IOS and Android devices, WEBRTC which facilitates communication between devices and the web server independent of the devices operating system, a web socket, and SignalR. WEBRTC (Web Real-Time Communication) is an API definition drafted by the World Wide Web Consortium (W3C) that supports browser-to-browser applications for voice calling, video chat, and P2P file sharing without the need of either internal or external plugins. APPRTC is similar to WEBRTC, but supports communications between IOS and Android devices. SignalR is an API that remote procedure calls from a server to connected clients and from clients to the server.

API calls may also be made to other services than may not require media information, which are handled in boxes 525 and 530. Those skilled in the art will understand that the various services and layers illustrated in FIGS. 4 and 5 are provided for exemplary purposes only; other services, functions and layers may also be provided without departing from the scope of the intended invention.

The exemplary embodiments of FIGS. 4 and 5 provide one example of a system providing an on-line interactive social learning experience for users using mobile to mobile communications. Such embodiments allow users running a mobile application on either IOS or Android devices to collaborate with each other. The collaboration features may include multi-user audio sharing, multi-user video sharing, one to one chat, group chat and other services. For example, the application will provide the ability to make multi-user audio calls or audio conferencing with each other independent of the operating systems of the user's devices.

In another embodiment, the mobile application may also provide a module allowing a user to upload a PDF document to the collaboration group, and then provide the ability to write over the PDF and share it with other users participating in a group session in real time. The application may also include an attend management module that controls the web server when introducing an IOS user to and Android user. Such an application may also provide information and/or reports related to usage of the system by users, or identify users who are misusing the system.

While some specific embodiments of the present invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The present invention is to be understood as not limited by the specific embodiments described herein, but only by scope of the appended claims.

I claim:

1. An online interactive social learning system which enables a multiplicity of end-users to interact in connection with educational areas of interest, comprising:
an educational services system configured on a server, the educational services system including a study tools package including a profile builder configured to enable an end-user to create a personal profile page, the study tools package also including an application for joining and/or creating a study group of one or more other end-user in accordance with educational criteria entered into the application by the end-user;
a host site in communication with the server, the host site providing the end-user access to the educational services system by way of an interface, the host site accessible by the end-user through a communications network; and
a database system in operable communication with the server and comprising a non-transient machine-readable medium for storing information related to the operation of the educational services system, including storing the personal profile page created by the end-user.

2. The social learning system of claim 1, wherein the study tools package includes one or more additional services that are provided to the end-users, the one or more services selected from the group consisting of a study groups pool, a collaboration tools package, and a tutoring tools package.

3. The social learning system of claim 1, wherein the profile builder enables the end-users to each create a personal profile page including one or more item of personal information, the one or more items of personal information selected from the group consisting of at least a username, a personal password, an identity of a school attended by the end-user, area of study, class schedule, existing study group memberships, and a membership status.

4. The social learning system of claim 2, wherein the study groups pool includes at least one software application stored on the server system providing access to the study groups pool by the end-user through the host site.

5. The social learning system of claim 4, wherein the study groups pool enables the end-users to search for and join one or more study groups, and to create new study groups.

6. The social learning system of claim 4, wherein the application configures the server to allow end-users to “buddy” each other so as to create study groups based on education-related criteria.

7. The social learning system of claim 4, wherein the application is configures the server to allow the end-users to specify whether the study groups created are public study groups or private study groups.

8. The social learning system of claim 7, wherein the public study groups are published by the application to the study groups pool, such that other end-users may search for and join the study groups.

9. The social learning system of claim 4, wherein information pertaining to existing study groups is stored on the database system, and wherein the interface is configured by software commands to provide for communication between the server, the study groups pool, and the information stored on the database system.

10. The social learning system of claim 2, wherein the collaboration tools package comprises a multiplicity of applications that include software commands to provide for interactions between end-users and to share educational information between end-users.

11. The social learning system of claim 10, wherein the collaboration tool package includes an interactive desktop application that, configured by software commands provided by the application, configures a desktop computer of an end-user of a study group, whereby each end-user may take study notes and also make those notes viewable, in real-time, to other end-users of the study group.

12. The social learning system of claim 11, wherein the study notes may be saved in the database and associated with the end-user's personal profile page.

13. The social learning system of claim 12, wherein each of the other end-users may specify whether or not other end-users can access the study notes associated with the personal profile page of the end-user.

14. The social learning system of claim 10, wherein the collaboration tools package comprises one or more video/audio conferencing applications, whereby the end-users comprising a study group may see and hear each other in real-time.

15. The social learning system of claim 10, wherein the collaboration tools package comprises an interactive whiteboard accessible by members of the study group, whereby the members of the study group may participate in adding and altering study-related content on the interactive whiteboard which is visible by all the members of the study group.

16. The social learning system of claim 10, wherein the collaboration tools package is stored on the memory of the server system and is accessible to the end-users by way of the interface and the host site.

17. The social learning system of claim 10, wherein the collaboration tools package may be stored on the memory of the database system along with the information pertaining to the operation of the collaboration tools package, and is accessible to the educational services system by way of the interface.

18. The social learning system of claim 2, wherein the tutoring tools package comprises one or more applications configured by software commands which facilitate the end-users searching for and receiving live, online tutoring services.

19. The social learning system of claim 18, wherein a multiplicity of tutors are selected from among the end-users that have demonstrated suitable skills in their chosen areas of study.

20. The social learning system of claim 18, wherein a multiplicity of tutors are employees or associates of an operator of the online interactive social learning system.

21. The social learning system of claim 18, wherein the online tutoring services are conveyed to the end-users by way of the one or more multimedia applications comprising the collaboration tools package.

22. The social learning system of claim 19, wherein the multiplicity of tutors post their rates and areas of specialty, thereby enabling the end-users to engage tutors based on specific needs.

23. The social learning system of claim 18, wherein the study groups pool has an indicator that identifies those among the end-users that are registered as tutors.

24. A method for providing an online interactive social learning system which enables a multiplicity of end-users to interact in connection with educational areas of interest, comprising:
configuring an educational services system to enable a multiplicity of end-users to create personal profile pages;
configuring a host site to provide the multiplicity of end-users with access to the educational services system by way of an interface;
storing the host site on a non-transient machine-readable medium of a social learning services server system such that the educational services system is accessible to the multiplicity of end-users by way of a communications network;
configuring a non-transient machine-readable medium of a database server system to store information needed during the operation of the educational services system;
providing a study groups pool to the multiplicity of end-users, whereby the end-users may search for and join one or more study groups based on educational criteria; and
providing a collaboration tools package comprising one or more multimedia applications, whereby the end-users may interact with one another by way of the communications network.

25. The method of claim 24, wherein providing the collaboration tools package further comprises providing an interactive desktop application, whereby each of the end-users may take study notes and also make those notes viewable, in real-time, to all the other end-users participating in the study group.

26. The method of claim 24, wherein providing the collaboration tools package further comprises providing one or more video/audio conferencing applications, whereby the end-users comprising the study group may see and hear each other in real-time.

27. The method of claim 24, wherein providing the collaboration tools package further comprises providing an interactive whiteboard, whereby the various end-users comprising each study group may simultaneously participate in adding and altering study-related content on the interactive whiteboard.

28. The method of claim 24, further comprising providing a tutoring tools package comprising one or more applications which facilitate the end-users searching for and receiving live, online tutoring services.

29. The method of claim 28, wherein providing the tutoring tools package further comprises selecting a multiplicity of tutors from among the end-users that have demonstrated suitable skills in their chosen areas of study.

30. The method of claim 28, wherein providing the tutoring tools package further comprises conveying the online tutoring services to the end-users by way of the one or more multimedia applications comprising the collaboration tools package.

31. The method of claim 24, further comprising providing a mobile application to the user to facilitate collaborative communications between IOS and Android devices.
